(19) United States
(12) Patent Application Publication
(10) Pub. No.: US 2026/0154859 A1
(43) Pub. Date: Jun. 4, 2026

(54) VIDEO GENERATION METHOD, APPARATUS, DEVICE AND MEDIUM

(71) Applicant: Beijing Zitiao Network Technology Co., Ltd., Beijing (CN)

(72) Inventors: Wenhe ZHAO, Beijing (CN); Yijun ZHAO, Beijing (CN); Xiaoping LUO, Beijing (CN); Kaibo YU, Beijing (CN); Jinju YANG, Beijing (CN); Weidong YANG, Beijing (CN); Junfeng HE, Beijing (CN); Hui REN, Beijing (CN); Gongmian WANG, Beijing (CN)

(21) Appl. No.: 19/401,084

(22) Filed: Nov. 25, 2025

(30) Foreign Application Priority Data
Nov. 29, 2024 (CN) 202411747652.1

(51) Int. Cl. G06T 11/00; G06T 7/70

(52) U.S. Cl. CPC G06T 11/00; G06T 7/70

(57) ABSTRACT

The disclosed embodiments relate to a video generation method, apparatus, device, and medium. The method comprises: obtaining product information of a target product; determining, based on the product information, character information corresponding to at least two target virtual characters; wherein the character information comprises character characteristics, character lines, and character appearance time; and generating a target video based on the character information of the target virtual characters; wherein the target video is a communication video of the at least two target virtual characters for the target product. The disclosed embodiments can directly generate a communication video of a plurality of virtual characters for the target product, requiring low cost and providing efficient production, thereby effectively showcasing and introducing the relevant product.

### CROSS-REFERENCE TO RELATED APPLICATION(S)

This application claims priority to Chinese Application No. 202411747652.1 filed on Nov. 29, 2024, the disclosure of which is incorporated herein by reference in its entity.

### FIELD

The present disclosure relates to the field of computer technology, and in particular to a video generation method, apparatus, device, and medium.

### BACKGROUND

To help customers clearly understand a product, it's often presented or introduced through images, text, or videos. Compared to the form of text and images, videos offer a clearer, more intuitive, and in-depth introduction to a product.

### SUMMARY

The present disclosure provides a video generation method, apparatus, device and medium.

The embodiment of the present disclosure provides a video generation method, the method comprising: acquiring product information of a target product;
based on the product information, determining character information corresponding to at least two target virtual characters; wherein the character information comprises character characteristics, character lines, and character appearance time; based on the character information of the target virtual characters, generating a target video; wherein the target video is a communication video of the at least two target virtual characters for the target product.

Optionally, determining the character information corresponding to at least two target virtual characters based on the product information, respectively, comprises: obtaining the character information corresponding to at least two target virtual characters, respectively, by using a preset generation model based on the product information and preset model prompt information.

Optionally, generating a target video based on the character information of the target virtual characters comprises: obtaining virtual representative objects corresponding to the target virtual characters based on the character characteristics of the target virtual characters; and obtaining a target video based on the character appearance time by having the virtual representative objects corresponding to the target virtual characters orally recite the character lines corresponding to the target virtual characters during the appearance.

Optionally, obtaining the virtual representative objects corresponding to the target virtual characters based on the character information of the target virtual characters comprises: based on the character characteristics corresponding to the target virtual characters, searching for the virtual representative objects corresponding to the target virtual characters from a preset virtual object library or generating the virtual representative objects corresponding to the target virtual characters through a generation model; wherein, the virtual representative objects corresponding to different target virtual characters are different.

Optionally, the searching for virtual representative objects corresponding to the target virtual characters from a preset virtual object library based on the character characteristics corresponding to the target virtual characters comprises: determining the target industry to which the target product belongs based on the product information; selecting candidate virtual objects corresponding to the target industry from a preset virtual object library; and searching for virtual representative objects corresponding to the target virtual characters from the candidate virtual objects corresponding to the target industry based on the character characteristics corresponding to the target virtual characters.

Optionally, the at least two target virtual characters include an interviewer character and an interviewee character; and searching for virtual representative objects corresponding to the target virtual characters from candidate virtual objects corresponding to the target industry based on the character characteristics corresponding to the target virtual characters comprises: searching for a candidate virtual object corresponding to the interviewer character from candidate virtual objects corresponding to the target industry based on the character characteristics corresponding to the interviewer character and preset action characteristics; searching for a candidate virtual object corresponding to the interviewee character from candidate virtual objects corresponding to the target industry based on the character characteristics corresponding to the interviewee character; performing deduplication processing on the searched candidate virtual object, and determining the virtual representative object corresponding to the interviewer character from the candidate virtual object corresponding to the interviewee character based on the deduplication result, and determining the virtual representative object corresponding to the interviewee character respectively from the candidate virtual object corresponding to the interviewee character.

Optionally, obtaining the target video by having the virtual representative objects corresponding to the target virtual characters orally recite the character lines corresponding to the target virtual characters during the appearance, comprises: determining the display positions of the virtual representative objects corresponding to the target virtual characters in the video frames based on a preset object display layouts; and obtaining the target video by having the virtual representative objects corresponding to the target virtual characters orally recite the character lines corresponding to the target virtual characters during the appearance based on the display positions.

Optionally, determining the display positions of the virtual representative objects corresponding to the target virtual characters in the video frames based on a preset object display layouts comprises: obtaining preset video segment division information, and determining a plurality of video segments based on the video segment division information; determining the object display layout corresponding to each of the plurality of video segments from the preset a plurality of object display layouts; and determining the display position of the virtual representative object corresponding to the target virtual characters in the video frame in the plurality of video segments based on the object display layout corresponding to each of the plurality of video segments.

The embodiment of the present disclosure also provides a video generation apparatus, comprising: a product information acquisition module, configured to obtain product information of a target product; a character information determination module, configured to determine character information corresponding to at least two target virtual characters based on the product information; wherein the character information comprises character characteristics, character lines and character appearance time; a video generation module, configured to generate a target video based on the character information of the target virtual characters; wherein the target video is a communication video of the at least two target virtual characters for the target product.

An embodiment of the present disclosure also provides an electronic device, comprising: a processor; a memory for storing instructions executable by the processor; the processor for reading the executable instructions from the memory and executing the instructions to implement the video generation method provided in the embodiment of the present disclosure.

The embodiments of the present disclosure further provide a computer-readable storage medium, wherein the storage medium stores a computer program, and the computer program is configured to execute the video generation method provided by the embodiments of the present disclosure.

The embodiments of the present disclosure further provide a computer program product, comprising a computer program, which, when executed by a processor, implements the video generation method provided in the embodiments of the present disclosure.

The method provided by the disclosed embodiments can determine the character information (comprising character characteristics, character lines, and appearance time) corresponding to at least two target virtual characters based on the acquired target product information. This allows the generation of a target video based on the character information of the target virtual characters. This target video is a communication video of the at least two target virtual characters for the target product. This method allows the direct generation a communication video of a plurality of virtual characters for the target product, with low cost and efficient production, effectively showcasing and introducing the relevant product.

It should be understood that the contents described in this section are not intended to identify the key or important features of the embodiments of the present disclosure, nor are they intended to limit the scope of the present disclosure. Other features of the present disclosure will become readily understood through the following description.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

In order to more clearly illustrate the embodiments of the present disclosure or the technical solutions in the prior art, the following briefly introduces the drawings required for use in the embodiments or the description of the prior art. Obviously, for ordinary technicians in this field, other drawings can be obtained based on these drawings without any creative work.

FIG. 1 is a schematic diagram of a flow chart of a video generation method provided by an embodiment of the present disclosure;

FIG. 2 is a schematic diagram of an object display layout provided by an embodiment of the present disclosure;

FIG. 3 is a schematic diagram of a video generation process provided by an embodiment of the present disclosure;

FIG. 4 is a schematic diagram of a segment of a target video provided by an embodiment of the present disclosure;

FIG. 5 is a schematic structural diagram of a video generating apparatus provided by an embodiment of the present disclosure;

FIG. 6 is a schematic structural diagram of an electronic device provided by an embodiment of the present disclosure.

### DETAILED DESCRIPTION OF EMBODIMENTS

Shooting and producing product-related videos needs to consume significant manpower, material resources, and capital, resulting in extremely high overall costs and low production efficiency.

In order to more clearly understand the above-mentioned objectives, features and advantages of the present disclosure, the scheme of the present disclosure will be further described below. It should be noted that the embodiments of the present disclosure and the features therein can be combined with each other in the absence of conflict.

In the following description, many specific details are set forth to facilitate a full understanding of the present disclosure, but the present disclosure may also be implemented in other ways different from those described herein; it is obvious that the embodiments in the specification are only part of the embodiments of the present disclosure, rather than all of the embodiments.

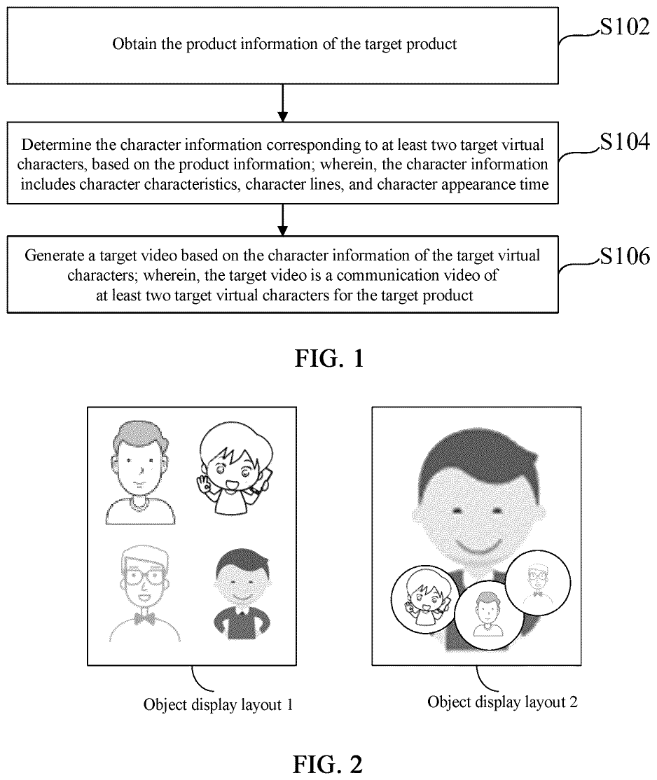

FIG. 1 is a flow chart of a video generation method provided by an embodiment of the present disclosure. The method can be performed by a video generation apparatus, wherein the apparatus can be implemented using software and/or hardware and can generally be integrated into an electronic device. As shown in FIG. 1, the method mainly comprises the following steps S102 to S106.

Step S102, product information of the target product is obtained. The embodiment of the present disclosure does not limit the target product, and any product that can be introduced through video can be used. For example, the target product can be any commodity or exhibit that requires a video introduction, or any place that requires a video introduction, such as a store, a tourist attraction, a building, or any event that requires a video introduction, such as a historical event, a scientific and technological event, etc. In short, the target product mentioned in the embodiment of the present disclosure can be any object that requires a video introduction. In addition, the embodiment of the present disclosure does not limit the product information. For example, the product information comprises, but is not limited to, one or more of the product name, product description, product advantages, the industry to which the product belongs, and the audience characteristics of the product. It can also further include specific product information based on the category of the target product. For example, if the target product is a commodity, the product information can also include product promotion information.

Step S104, based on the product information, the character information corresponding to at least two target virtual characters are determined, respectively; wherein the character information comprises character characteristics, character lines, and character appearance time; wherein the character characteristics may be, for example, characteristics of designated parts of the character, character decoration characteristics, character timbre characteristics, etc. In addition, the character information may also include information such as the character appearance environment, etc., which is not limited here.

In some embodiments, the powerful processing capabilities of the generative model can be used to directly generate, based on the product information, character information corresponding to at least two target virtual characters that match the product information. It should be noted that the disclosed embodiment does not limit the type of target virtual characters, and the specific settings can be flexibly set. In order to attract customers and increase the degree of persuasion, for example, the at least two target virtual characters include an interviewer character and an interviewee character. The disclosed embodiment does not limit the specific number of each character, such as one interviewer character and a plurality of interviewee characters. The interviewer character can be used to ask questions about the product, and the interviewee character can be used to express feelings about the product. The purpose of product promotion is achieved by using an interactive form of a plurality of virtual characters.

Step S106, a target video is generated based on the character information of the target virtual characters; wherein the target video is a communication video of at least two target virtual characters for the target product.

In the case that the character information, such as the character characteristics, character lines, and character appearance time of the target virtual characters, is obtained, video production can be carried out to directly generate a communication video of a plurality of virtual characters for the target product. The cost is low, the production is efficient, and the related products can be better displayed and introduced.

In some embodiments, based on the product information and the preset model prompt information, the preset generation model can be used to obtain the character information corresponding to at least two target virtual characters. The generation model is a neural network model with generation capabilities, which can be obtained through pre-training. The embodiment of the present disclosure does not limit the structure of the generation model. The model prompt information is used to instruct the generation model to output the respective character information of at least two target virtual characters based on the product information, thereby generating a product promotion video. In actual applications, the specific content of the model prompt information can be flexibly set according to requirements. For example, the model prompt information comprises task prompt information, script prompt information, character prompt information, etc. For example, the task prompt information can use descriptive text such as “You are a short video script expert. Your task is to design a product promotion video script for small and medium-sized e-commerce merchants with independent stores.” The script prompt information can use descriptive text such as “The script should follow the following order: an attracting attention segment, a segment of an interviewer initiating a conversation, and a segment of an interviewee sharing opinions, an interviewer summary segment.” Script prompt information can also include conditional text descriptions corresponding to each segment, such as duration conditions and notes on the lines of participating characters. Character prompt information can include character requirements required in the video, such as the interviewer and interviewee characters need to appear in the video. It can also contain requirements for the number, characteristics, and appearances of required characters. It can be configured flexibly. The above are examples and should not be considered limiting. In actual applications, model prompt information can be flexibly configured according to needs, thus, with the help of the generation model, the character information corresponding to each target virtual character, such as character characteristics, character lines and character appearance time can be output.

In some embodiments, the specific steps of generating a target video based on the character information of the target virtual characters may be performed with reference to the following steps A and B.

Step A, based on the character characteristics of the target virtual characters, virtual representative objects corresponding to the target virtual characters are obtained. The virtual representative objects can be, for example, digital human images. In specific implementation, based on the character characteristics of the target virtual characters, the virtual representative objects corresponding to the target virtual characters can be searched from a preset virtual object library or generated by a generation model, wherein different target virtual characters correspond to different virtual representative objects. That is, in some implementation examples, the generation model can be directly used to generate virtual representative objects that match the character characteristics of the target virtual characters. In this way, the virtual representative objects with a high degree of match with the character characteristics of the target virtual characters can be generated in a targeted manner with the help of the model, that is, customized virtual representative objects are obtained. In other implementation examples, in order to efficiently obtain the virtual representative objects corresponding to the target virtual characters, the virtual representative objects corresponding to the target virtual characters can be searched from a preset virtual object library based on the character characteristics of the target virtual characters; wherein different target virtual characters correspond to different virtual representative objects. In other words, a virtual object library containing a variety of virtual objects can be pre-built. The virtual objects with the highest similarity to the character characteristics of the target virtual characters can be directly searched from the virtual object library to obtain the virtual representative objects corresponding to the target virtual characters. This method can more efficiently and quickly obtain virtual representative objects that substantially match the character characteristics of the target virtual characters, reducing time and cost. In actual applications, any of the above methods can be flexibly adopted as needed, and this is not limited here.

In some specific implementation examples, the above steps are performed with reference to steps 1 to 3 as follows.

Step 1, the target industry of the target product is determined based on the product information. In some implementation examples, the product information may include the industry information of the product, so the target industry of the target product can be directly identified from this information. In other implementation examples, the product information may only include the product name, product introduction, etc., so the target industry of the target product can be determined by analyzing the product information.

Step 2, candidate virtual objects corresponding to the target industry are selected from the preset virtual object library. In actual applications, each virtual object in the virtual object library can be set with corresponding attribute tags, such as characteristic tags, industry tags, etc., and virtual objects with target industry tags can be extracted from the virtual object library as candidate virtual objects. It is understandable that the characteristics of the target audience of products are different depending on the industry to which the products belong. Through the above method, a batch of candidate virtual objects that match the product can be efficiently screened out based on the industry, which reasonably narrows the selection range of candidate virtual objects and ensures that the virtual representative objects communicating about the target product finally obtained all meet the characteristics of the product audience, which helps to further enhance the persuasiveness of the target video finally obtained.

Step 3, based on the character characteristics corresponding to the target virtual characters, virtual representative objects corresponding to the target virtual characters are search from the candidate virtual objects corresponding to the target industry. In some specific examples, the at least two target virtual characters include an interviewer and an interviewee. Based on this, Step 3 can be performed with reference to Steps 3.1 to 3.3 as follows.

Step 3.1, based on the character characteristics and preset action characteristics corresponding to the interviewer character, candidate virtual objects corresponding to the target industry are searched from the candidate virtual objects corresponding to the target industry. In actual applications, in addition to the character characteristics corresponding to the interviewer character given by the generation model, the action characteristics that the candidate virtual objects corresponding to the interviewer character need to meet can also be preset according to actual conditions, so as to fully ensure that the candidate virtual objects corresponding to the interviewer character can better represent the interviewer character. The embodiment of the present disclosure does not limit the above-mentioned preset action characteristics. For example, the above-mentioned preset action characteristics can include handheld microphone characteristics. The embodiment of the present disclosure does not limit the number of candidate virtual objects corresponding to the interviewer character, and specifically, the number threshold that needs to be met can be flexibly set.

Step 3.2, based on the character characteristics of the interviewee character, candidate virtual objects corresponding to the target industry are searched. This embodiment of the disclosure does not limit the number of candidate virtual objects corresponding to the interviewee character, and specifically, the number threshold that needs to be met can be flexibly set.

In step 3.3, deduplication processing is performed on the searched candidate virtual objects, and based on the deduplication results, the virtual representative objects corresponding to the interviewer character are determined from the candidate virtual objects corresponding to the interviewer character, and the virtual representative objects corresponding to the interviewee character are determined from the candidate virtual objects corresponding to the interviewee character. It is understandable that there may be duplicate objects among the searched candidate virtual objects above, so deduplication processing can be performed to ensure that the virtual representative objects corresponding to different characters are different. In addition, if there are still a plurality of candidate virtual objects corresponding to the same character after deduplication processing, then based on the similarity between the characteristics of the character and the characteristics of the corresponding candidate virtual objects, the candidate virtual objects with the highest similarity can be selected as the virtual representative object corresponding to the character.

Step B, based on the character appearance time, a target video is obtained by having virtual representative objects corresponding to the target virtual characters recite the character lines during the appearance. In practical applications, the character lines and the character appearance time have a mapping relationship. Based on the character appearance time, an animated video can be generated in which the virtual representative objects corresponding to the target virtual characters recite the character lines corresponding to the target virtual characters during the appearance time, thereby the target video is obtained. The appearance time of different characters can be the same or different, and there is no limitation here.

In some specific examples, the following steps (1) and (2) may be referred to for execution.

Step (1), display positions of the virtual representative objects corresponding to the target virtual characters in video frames are determined based on the preset object display layouts. The object display layouts can be used to indicate the display positions of the virtual representative objects corresponding to each target virtual character in the video frames. In addition, it should be noted that the same virtual representative object may appear a plurality of times in the target video, and the display positions corresponding to different appearance time can be the same or different, and can be flexibly set. For the same video frame, only one virtual representative object can be displayed, or a plurality of virtual representative objects can be displayed at the same time, that is, a plurality of virtual representative objects can appear at the same time, which can be determined by the appearance time corresponding to each virtual representative object. Referring to a schematic diagram of an object display layout shown in FIG. 2, two object display layouts are illustrated. Object display layout 1 displays four virtual representative objects in a four-grid format, and object display layout 2 displays one virtual representative object in full screen, and then superimposes and displays three virtual representative objects. FIG. 2 is only an example. In actual application, the object display layout can be flexibly set and is not limited here. In addition, the target video to be generated can be divided into a plurality of segments, and the object display layouts corresponding to the video frames in different segments can be different. On this basis, the above step (1) can be performed with reference to the following steps (1.1) to (1.3).

(1.1) Preset video segment division information is obtained and determining a plurality of video segments based on the video segment division information. In practical applications, the required video segments can be pre-set. For example, the video can be divided into four segments: an attracting attention segment, a segment of an interviewer initiating a conversation, and a segment of an interviewee sharing opinions, an interviewer summary segment.

(1.2) The object display layouts corresponding to each of the plurality of video segments are determined from the preset a plurality of object display layouts. In actual applications, a plurality of object display layouts can be set in advance. The object display layouts include layouts for displaying only a single object and layouts for displaying a plurality of objects at the same time. The positions of the same virtual representative object in different object display layouts can be the same or different. For the layout for displaying a plurality of objects, the positions of the plurality of virtual representative objects or the relative positional relationship between different virtual representative objects can be indicated. The embodiment of the present disclosure can determine the object display layout corresponding to each video segment based on the characteristics of each video segment, or directly determine the object display layout corresponding to each video segment based on the mapping relationship between the preset object display layout and the video segment. For example, for an interviewer to start a lines segment, it is suitable for displaying a layout of a plurality of objects. For ease of understanding, the following examples are provided: in the video frame of the attention-attracting segment, a virtual representative object corresponding to one interviewee character can be displayed alone, or virtual representative objects corresponding to four interviewee characters can be displayed simultaneously; in the video frame of the segment of an interviewer initiating a conversation, a virtual representative object corresponding to the interviewer character can be displayed alone, or a virtual representative object corresponding to the interviewer character and virtual representative objects corresponding to a plurality of interviewee characters can be displayed simultaneously; in the video frames of the segment of the interviewee sharing opinions and the interviewer summary segment, a virtual representative object corresponding to one respective character can be displayed alone. Through the above methods, the object display layout of each video segment can be reasonably determined so that the virtual representative objects can have reasonable display positions in different video segments.

(1.3) Based on the object display layouts corresponding to multiple video segments, the display positions of the virtual representative objects corresponding to the target virtual character in the video frames in multiple video segments are determined. Since the object display layout is used to indicate the display positions of the virtual representative objects corresponding to each target virtual character in the video, the display positions of the virtual representative objects in the video frame of each video segment can be determined based on the object display layouts corresponding to each video segment, such as the center position, the upper left corner position, the lower right corner position, or a specific position of the video frame, which will not be listed here.

In step (2), based on the display positions, obtaining the target video by having the virtual representative objects corresponding to the target virtual characters orally recite the character lines corresponding to the target virtual characters during the appearance. Specifically, based on the display position corresponding to each moment, a target video is generated by having the virtual representative objects corresponding to the target virtual characters orally recite the respective character lines, thereby presenting a video of a plurality of target virtual characters communicating about the target product to the customer.

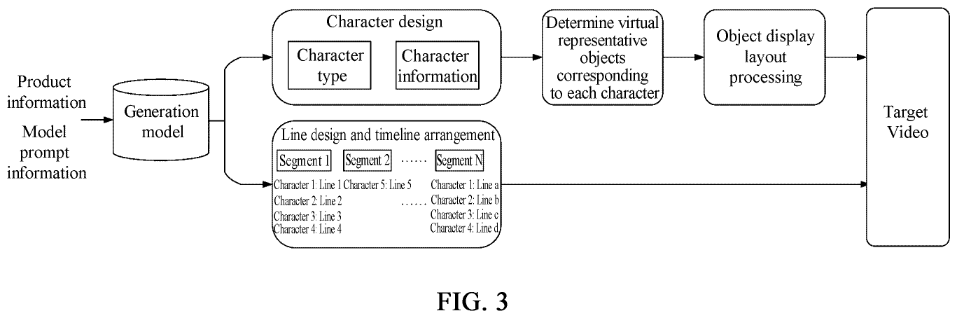

For easier understanding, it can be referred to a schematic diagram of the video generation process shown in FIG. 3. This diagram illustrates how product information and model prompt information are input into the generation model. The generation model can output character design content, lines design, and timeline arrangement content. Furthermore, based on the character design content, virtual representative objects corresponding to each character are selected from the virtual object library. Object display layout processing is then performed to generate the target video. The specific implementation methods of these steps can be referenced in related technologies and will not be detailed here.

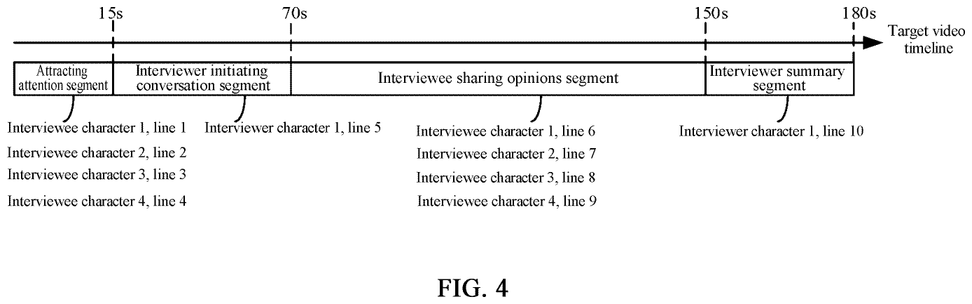

Based on the above, it can be referred to a schematic diagram of the content segments of a target video shown in FIG. 4. The target video illustrates four segments: an attracting attention segment (0-15 s), a segment of an interviewer initiating conversation (15-70 s), a segment of an interviewee sharing opinion (70-150 s), and interviewer summary segment (150-180 s). The target video also illustrates the target virtual characters that appear in each segment. Take the target video where there is one interviewer character and four interviewee characters in total as an example for illustration. For example, during the attracting attention segment, the lines of each of the four interviewees are as follows: line 1 of interviewee character 1:“It is very suitable”; line 2 of interviewee 2:“It fits perfectly”; line 3 of interviewee 3:“It's super suitable ”; line 4 of interviewee 4:“My dog loves it. It fits perfectly.” During the segment of an interviewer initiating a conversation, line 5 of interviewer 1:“Hey! dog owners, today we're going to learn about XX brand chest strap for dogs. Let's see why they're a favorite among dogs and their owners.” During the segment of an interviewee sharing opinions, the lines of the four interviewee characters are as follows: line 6 of interviewee 1:“Putting it on my dog is so easy, no hassle at all”; line 7 of interviewee 2: “The connection option of traction rope is a game-changing design for walking”; line 8 of interviewee 3:“My dog loves wearing it, the strap fits it perfectly”; line 9 of interviewee 4: “Also, the ID pocket equipped on the strap is so convenient.” During the interviewer summary segment, line 10 of interviewer 1: “That's it! A comfortable, adjustable chest strap perfect for your dog's adventures. Buy it now and get 20% off on Friday! Don't miss out!” By using the above method, a plurality of virtual representative objects can be used to simulate buyers expressing their product experience, creating a simulated interview, survey, or other plot effect, effectively enhancing the effectiveness of product introductions. It should be noted that the above are merely examples and should not be considered limiting. In actual applications, the required segments in the video, as well as the virtual characters and corresponding lines that appear in each segment, can be flexibly configured according to needs.

In summary, through the above-mentioned video generation method, it is possible to directly generate a communication video of a plurality of virtual characters for a target product. The cost is low, the production is efficient, and the related products can be well displayed and introduced, thereby effectively improving the product introduction effect.

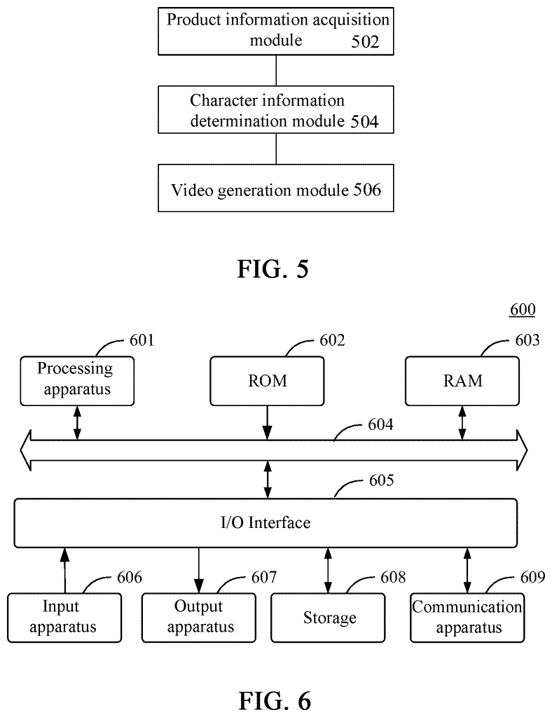

Corresponding to the aforementioned video generation method, the embodiments of the present disclosure further provide a video generation apparatus. FIG. 5 is a schematic structural diagram of a video generation apparatus provided by an embodiment of the present disclosure. The apparatus can be implemented by software and/or hardware and can generally be integrated into an electronic device. As shown in FIG. 5, the video generation apparatus comprises:
a product information acquisition module 502, configured to obtain product information of the target product;
a character information determination module 504, configured to determine the character information corresponding to at least two target virtual characters based on the product information; wherein the character information comprises character characteristics, character lines, and character appearance time;
a video generation module 506, configured to generate a target video based on the character information of the target virtual characters; wherein the target video is a communication video of at least two target virtual characters for a target product.

Through the above apparatus, communication videos of multiple virtual characters for the target product can be directly generated, with low cost and high efficiency, and can better display and introduce related products.

In some embodiments, the character information determination module 504 is specifically configured to obtain character information corresponding to at least two target virtual characters using a preset generation model based on the product information and preset model prompt information.

In some embodiments, the character appearance time comprises the character appearance time; the video generation module 506 is specifically configured to: obtain virtual representative objects corresponding to the target virtual characters based on the character characteristics of the target virtual characters; based on the character appearance time, obtain a target video by having the virtual representative objects corresponding to the target virtual characters orally recite the character lines corresponding to the target virtual characters during the appearance.

In some embodiments, the video generation module 506 is specifically configured to: based on the character characteristics corresponding to the target virtual characters, search for the virtual representative objects corresponding to the target virtual characters from a preset virtual object library or generate the virtual representative objects corresponding to the target virtual characters by a generation model; wherein, the virtual representative objects corresponding to different target virtual characters are different.

In some embodiments, the video generation module 506 is specifically configured to: determine the target industry to which the target product belongs based on the product information; select candidate virtual objects corresponding to the target industry from a preset virtual object library; and search for virtual representative objects corresponding to the target virtual characters from the candidate virtual objects corresponding to the target industry based on the character characteristics corresponding to the target virtual characters.

In some embodiments, the at least two target virtual characters include an interviewer character and an interviewee character; the video generation module 506 is specifically configured to: based on the character characteristics corresponding to the interviewer character and preset action characteristics, search for the candidate virtual object corresponding to the interviewer character from the candidate virtual objects corresponding to the target industry; based on the character characteristics corresponding to the interviewee character, search for the candidate virtual object corresponding to the interviewee character from the candidate virtual objects corresponding to the target industry; perform deduplication processing on the searched candidate virtual objects, and based on the deduplication result, determine the virtual representative object corresponding to the interviewer character from the candidate virtual objects corresponding to the interviewer character, and determine the virtual representative objects corresponding to the interviewee character from the candidate virtual objects corresponding to the interviewee character.

In some embodiments, the video generation module 506 is specifically configured to: determine the display positions of the virtual representative objects corresponding to the target virtual characters in the video frames based on preset object display layouts; based on the display positions, obtain the target video by having the virtual representative objects corresponding to the target virtual characters orally recite the character lines corresponding to the target virtual characters during the appearance.

In some embodiments, the video generation module 506 is specifically configured to: obtain preset video segment division information, and determine a plurality of video segments based on the video segment division information; determine the object display layout corresponding to each of the plurality of video segments from a plurality of preset object display layouts; based on the object display layout corresponding to each of the plurality of video segments, determine the display positions of the virtual representative objects corresponding to the target virtual characters in the video frames of the plurality of video segments.

The video generation apparatus provided in the embodiments of the present disclosure can execute the video generation method provided in any embodiment of the present disclosure, and has the corresponding functional modules and beneficial effects of the execution method.

Those skilled in the art can clearly understand that, for the convenience and brevity of description, the specific working process of the above-described apparatus embodiment can refer to the corresponding process in the method embodiment, and will not be repeated here.

An embodiment of the present disclosure provides an electronic device, which comprises: a storage device storing a computer program; and a processing device configured to execute the computer program in the storage device to implement the steps of any one of the methods in the present disclosure.

Reference is now made to FIG. 6, which illustrates a schematic diagram of the structure of an electronic device 600 suitable for implementing embodiments of the present disclosure. Terminal devices in embodiments of the present disclosure may include, but are not limited to, mobile terminals such as mobile phones, laptop computers, digital broadcast receivers, PDAs (personal digital assistants), PADs (tablet computers), PMPs (portable multimedia players), in-vehicle terminals (e.g., in-vehicle navigation terminals), and fixed terminals such as digital TVs and desktop computers. The electronic device illustrated in FIG. 6 is merely an example and should not limit the functionality or scope of application of embodiments of the present disclosure.

As shown in FIG. 6, electronic device 600 may include a processing apparatus (e.g., a central processing unit, a graphics processing unit, etc.) 601, which can perform various appropriate actions and processes based on programs stored in a read-only memory (ROM) 602 or programs loaded from a storage apparatus 608 into a random access memory (RAM) 603. RAM 603 also stores various programs and data required for the operation of electronic device 600. Processing apparatus 601, ROM 602, and RAM 603 are connected to each other via a bus 604. An input/output (I/O) interface 605 is also connected to bus 604.

Typically, the following devices may be connected to the I/O interface 605: an input apparatus 606 comprising, for example, a touch screen, touchpad, keyboard, mouse, camera, microphone, accelerometer, gyroscope, etc.; an output device 607 comprising, for example, a liquid crystal display (LCD), speaker, vibrator, etc.; a storage 608 comprising, for example, a magnetic tape, hard disk, etc.; and a communication apparatus 609. The communication apparatus 609 may allow the electronic device 600 to communicate with other devices wirelessly or by wire to exchange data. Although FIG. 6 illustrates the electronic device 600 with various apparatus, it should be understood that not all of the illustrated devices are required to be implemented or present. More or fewer devices may alternatively be implemented or present.

In particular, according to an embodiment of the present disclosure, the process described above with reference to the flowchart can be implemented as a computer software program. For example, an embodiment of the present disclosure comprises a computer program product, which comprises a computer program carried on a non-transitory computer-readable medium, and the computer program comprises a program code for executing the method shown in the flowchart. In such an embodiment, the computer program can be downloaded and installed from the network through the communication apparatus 609, or installed from the storage 608, or installed from the ROM 602. When the computer program is executed by the processing apparatus 601, the above-mentioned functions defined in the method of the embodiment of the present disclosure are performed.

In addition to the above-mentioned methods and devices, the embodiments of the present disclosure may also be a computer program product, which comprises computer program instructions, which, when executed by a processor, cause the processor to perform the method provided by the embodiments of the present disclosure. The computer program product can be written in any combination of one or more programming languages to write program codes for performing the operations of the embodiments of the present disclosure, and the programming languages include object-oriented programming languages such as Java, C++, etc., and also include conventional procedural programming languages such as “C” language or similar programming languages. The program code can be executed entirely on the user computing device, partially on the user device, as a separate software package, partially on the user computing device and partially on a remote computing device, or entirely on a remote computing device or server.

In addition, the embodiment of the present disclosure may also be a computer-readable storage medium having computer program instructions stored thereon. When the computer program instructions are executed by a processor, the processor is enabled to execute the video generation method provided by the embodiment of the present disclosure.

The computer-readable storage medium may be any combination of one or more readable media. The readable medium may be a readable signal medium or a readable storage medium. The readable storage medium may include, for example, but is not limited to, an electrical, magnetic, optical, electromagnetic, infrared, or semiconductor system, device, or device, or any combination thereof. More specific examples (a non-exhaustive list) of readable storage media include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The embodiments of the present disclosure further provide a computer program product, comprising a computer program/instruction, which implements the video generation method in the embodiments of the present disclosure when the computer program/instruction is executed by a processor.

It is understandable that before using the technical solutions disclosed in the various embodiments of this disclosure, the type, scope of use, usage scenarios, etc. of the personal information involved in this disclosure should be informed to the user and the user's authorization should be obtained in an appropriate manner in accordance with relevant laws and regulations.

For example, in response to receiving a user's active request, a prompt message is sent to the user to clearly inform the user that the operation requested will require the acquisition and use of the user's personal information. This allows the user to independently choose whether to provide personal information to the electronic device, application, server, storage medium, or other software or hardware that performs the operations of the disclosed technical solution based on the prompt message.

As an optional but non-limiting implementation, in response to receiving a user's active request, the prompt information may be sent to the user in the form of a pop-up window, in which the prompt information may be presented in text form. Furthermore, the pop-up window may also contain a selection control for the user to select “agree” or “disagree” to provide personal information to the electronic device.

It is understandable that the above notification and user authorization process are merely illustrative and do not constitute a limitation on the implementation of the present disclosure. Other methods that comply with relevant laws and regulations may also be applied to the implementation of the present disclosure.

It should be noted that, in this document, relational terms such as “first” and “second” are used only to distinguish one entity or operation from another entity or operation, and do not necessarily require or imply any actual relationship or order between these entities or operations. Moreover, the terms “comprises,” “comprising,” or any other variations thereof are intended to cover non-exclusive inclusion, so that a process, method, article, or device comprising a series of elements comprises not only those elements, but also other elements not explicitly listed, or elements inherent to such process, method, article, or device. In the absence of further limitations, an element defined by the phrase “comprising a . . . ” does not exclude the presence of other identical elements in the process, method, article, or device comprising the element.

The foregoing description is intended only to provide specific embodiments of the present disclosure, intended to enable those skilled in the art to understand and implement the present disclosure. Various modifications to these embodiments will be readily apparent to those skilled in the art, and the general principles defined herein may be implemented in other embodiments without departing from the spirit or scope of the present disclosure. Therefore, the present disclosure is not intended to be limited to the embodiments described herein, but rather to be construed in the broadest manner consistent with the principles and novel features disclosed herein.

I/We claim:

1. A video generation method, comprising:
obtaining product information of a target product;
determining character information corresponding to at least two target virtual characters, respectively, based on the product information, wherein the character information comprises character characteristics, character lines, and character appearance time; and
generating a target video based on the character information of the target virtual characters, wherein the target video is a communication video of the at least two target virtual characters for the target product.

2. The method according to claim 1, wherein determining the character information corresponding to the at least two target virtual characters based on the product information, respectively, comprises:
obtaining the character information corresponding to the at least two target virtual characters, respectively, by using the preset generation model, based on the product information and the preset model prompt information.

3. The method according to claim 1, wherein generating the target video based on the character information of the target virtual characters comprises:
obtaining virtual representative objects corresponding to the target virtual characters, based on the character characteristics of the target virtual characters; and
obtaining, based on the character appearance time, the target video by having the virtual representative objects corresponding to the target virtual characters orally recite the character lines corresponding to the target virtual characters during the appearance time.

4. The method according to claim 3, wherein obtaining the virtual representative objects corresponding to the target virtual characters based on the character information of the target virtual characters comprises:
searching for the virtual representative objects corresponding to the target virtual characters from a preset virtual object library or generating the virtual representative objects corresponding to the target virtual characters by a generation model, based on the character characteristics corresponding to the target virtual characters, wherein different target virtual characters correspond to different virtual representative objects.

5. The method according to claim 4, wherein searching for the virtual representative objects corresponding to the target virtual characters from the preset virtual object library based on the character characteristics corresponding to the target virtual characters comprises:
determining a target industry to which the target product belongs based on the product information;
selecting candidate virtual objects corresponding to the target industry from the preset virtual object library; and
searching for the virtual representative objects corresponding to the target virtual characters from the candidate virtual objects corresponding to the target industry, based on the character characteristics corresponding to the target virtual characters.

6. The method according to claim 5, wherein the at least two target virtual characters comprise an interviewer character and an interviewee character;
wherein searching for the virtual representative objects corresponding to the target virtual characters from the candidate virtual objects corresponding to the target industry, based on the character characteristics corresponding to the target virtual characters comprises:
searching for a candidate virtual object corresponding to the interviewer character from the candidate virtual objects corresponding to the target industry, based on a character characteristic and a preset action characteristic corresponding to the interviewer character;
searching for a candidate virtual object corresponding to the interviewee character from the candidate virtual objects corresponding to the target industry, based on a character characteristic corresponding to the interviewee character; and
performing deduplication processing on the searched candidate virtual objects, and based on a result of the deduplication, determining a virtual representative object corresponding to the interviewer character from the candidate virtual objects corresponding to the interviewer character, and determining a virtual representative object corresponding to the interviewee character from the candidate virtual objects corresponding to the interviewee character.

7. The method according to claim 3, wherein obtaining the target video by having the virtual representative objects corresponding to the target virtual characters orally recite the character lines corresponding to the target virtual characters during the appearance time comprises:
determining display positions of the virtual representative objects corresponding to the target virtual characters in video frames based on preset object display layouts; and
obtaining the target video by having the virtual representative objects corresponding to the target virtual characters orally recite the character lines corresponding to the target virtual characters during the appearance time, based on the display positions.

8. The method according to claim 7, wherein determining the display positions of the virtual representative objects corresponding to the target virtual characters in the video frames based on the preset object display layouts comprises:
obtaining preset video segment division information, and determining a plurality of video segments based on the video segment division information;
determining the object display layout corresponding to each of the plurality of video segments from a plurality of preset object display layouts; and
determining the display positions of the virtual representative objects corresponding to the target virtual characters in the video frames of the plurality of video segments, based on the object display layouts corresponding to each of the plurality of video segments.

9. An electronic device, comprising:
a storage having a computer program stored thereon;
a processing apparatus, configured to execute the computer program in the storage to:
obtain product information of a target product;
determine character information corresponding to at least two target virtual characters, respectively, based on the product information, wherein the character information comprises character characteristics, character lines, and character appearance time; and
generate a target video based on the character information of the target virtual characters, wherein the target video is a communication video of the at least two target virtual characters for the target product.

10. The electronic device according to claim 9, wherein the computer program causing the processing apparatus to determine the character information corresponding to the at least two target virtual characters based on the product information, respectively, comprises instructions to:
obtain the character information corresponding to the at least two target virtual characters, respectively, by using the preset generation model, based on the product information and the preset model prompt information.

11. The electronic device according to claim 9, wherein the computer program causing the processing apparatus to generate the target video based on the character information of the target virtual characters comprises instructions to:
obtain virtual representative objects corresponding to the target virtual characters, based on the character characteristics of the target virtual characters; and
obtain, based on the character appearance time, the target video by having the virtual representative objects corresponding to the target virtual characters orally recite the character lines corresponding to the target virtual characters during the appearance time.

12. The electronic device according to claim 11, wherein the computer program causing the processing apparatus to obtain the virtual representative objects corresponding to the target virtual characters based on the character information of the target virtual characters comprises instructions to:
search for the virtual representative objects corresponding to the target virtual characters from a preset virtual object library or generate the virtual representative objects corresponding to the target virtual characters by a generation model, based on the character characteristics corresponding to the target virtual characters, wherein different target virtual characters correspond to different virtual representative objects.

13. The electronic device according to claim 12, wherein the computer program causing the processing apparatus to search for the virtual representative objects corresponding to the target virtual characters from the preset virtual object library based on the character characteristics corresponding to the target virtual characters comprises instructions to:
determine a target industry to which the target product belongs based on the product information;
select candidate virtual objects corresponding to the target industry from the preset virtual object library; and
search for the virtual representative objects corresponding to the target virtual characters from the candidate virtual objects corresponding to the target industry, based on the character characteristics corresponding to the target virtual characters.

14. The electronic device according to claim 13, wherein the at least two target virtual characters comprise an interviewer character and an interviewee character;
wherein the computer program causing the processing apparatus to search for the virtual representative objects corresponding to the target virtual characters from the candidate virtual objects corresponding to the target industry, based on the character characteristics corresponding to the target virtual characters comprises instructions to:
search for a candidate virtual object corresponding to the interviewer character from the candidate virtual objects corresponding to the target industry, based on a character characteristic and a preset action characteristic corresponding to the interviewer character;
search for a candidate virtual object corresponding to the interviewee character from the candidate virtual objects corresponding to the target industry, based on a character characteristic corresponding to the interviewee character; and
perform deduplication processing on the searched candidate virtual objects, and based on a result of the deduplication, determine a virtual representative object corresponding to the interviewer character from the candidate virtual objects corresponding to the interviewer character, and determine a virtual representative object corresponding to the interviewee character from the candidate virtual objects corresponding to the interviewee character.

15. The electronic device according to claim 11, wherein the computer program causing the processing apparatus to obtain the target video by having the virtual representative objects corresponding to the target virtual characters orally recite the character lines corresponding to the target virtual characters during the appearance time comprises instructions to:
determine display positions of the virtual representative objects corresponding to the target virtual characters in video frames based on preset object display layouts; and
obtain the target video by having the virtual representative objects corresponding to the target virtual characters orally recite the character lines corresponding to the target virtual characters during the appearance time, based on the display positions.

16. The electronic device according to claim 11, wherein the computer program causing the processing apparatus to determine the display positions of the virtual representative objects corresponding to the target virtual characters in the video frames based on the preset object display layouts comprises instructions to:
obtain preset video segment division information, and determine a plurality of video segments based on the video segment division information;
determine the object display layout corresponding to each of the plurality of video segments from a plurality of preset object display layouts; and
determine the display positions of the virtual representative objects corresponding to the target virtual characters in the video frames of the plurality of video segments, based on the object display layouts corresponding to each of the plurality of video segments.

17. A non-transitory computer-readable storage medium, wherein the storage medium stores a computer program, wherein the computer program is used to:
obtain product information of a target product;
determine character information corresponding to at least two target virtual characters, respectively, based on the product information, wherein the character information comprises character characteristics, character lines, and character appearance time; and
generate a target video based on the character information of the target virtual characters, wherein the target video is a communication video of the at least two target virtual characters for the target product.

18. The storage medium according to claim 17, wherein the computer program used to determine the character information corresponding to the at least two target virtual characters based on the product information, respectively, comprises instructions to:
obtain the character information corresponding to the at least two target virtual characters, respectively, by using the preset generation model, based on the product information and the preset model prompt information.

19. The storage medium according to claim 17, wherein the computer program used to generate the target video based on the character information of the target virtual characters comprises instructions to:
obtain virtual representative objects corresponding to the target virtual characters, based on the character characteristics of the target virtual characters; and
obtain, based on the character appearance time, the target video by having the virtual representative objects corresponding to the target virtual characters orally recite the character lines corresponding to the target virtual characters during the appearance time.

20. The storage medium according to claim 19, wherein the computer program used to obtain the virtual representative objects corresponding to the target virtual characters based on the character information of the target virtual characters comprises instructions to:
search for the virtual representative objects corresponding to the target virtual characters from a preset virtual object library or generate the virtual representative objects corresponding to the target virtual characters by a generation model, based on the character characteristics corresponding to the target virtual characters, wherein different target virtual characters correspond to different virtual representative objects.
